(19) United States
(12) Patent Application Publication
(10) Pub. No.: US 2011/0097636 A1
(43) Pub. Date: Apr. 28, 2011

(54) Disconnecting Procedure For Fuel Cell Systems

(75) Inventors: Michael Kurrle, Kirchheim (DE); Mathias Lederbogen, Blaubeuren (DE); Gerald Post, Suessen (DE); Volker Schempp, Holzmaden (DE); Klaus Weigele, Schlierbach (DE)

(73) Assignee: DaimlerChrysler AG, Stuttgart (DE)

(21) Appl. No.: 11/632,680

(22) PCT Filed: Jun. 28, 2005
(86) PCT No.: PCT/EP2005/006923

§ 371 Date: Aug. 6, 2007

(30) Foreign Application Priority Data
Jul. 15, 2004 (DE) 10 2004 034 071.4

(51) Int. Cl. H01M 8/04

(52) U.S. Cl. 429/429

(57) ABSTRACT

A method for shutting down a fuel cell system having at least one fuel cell, especially a fuel cell provided with a proton exchanging membrane, anode and cathode inlets, anode and cathode outlets, an anode recirculation circuit, a device which is operated according to the Venturi principle and is used to convey the gas in the anode recirculation circuit, and a hydrogen and air supply is disclosed. A method characterized by low emission values and high efficiency is provided. The hydrogen supply to the anode is interrupted during shutdown of the fuel cell system and the current generated from the residual hydrogen is supplied to an electric consumer.

The present invention relates to a method for shutting down a fuel cell system.

Fuel cell systems are used as a power source in many applications, e.g., for the drive or other units in motor vehicles. The most widely used here are fuel cells having proton exchange membranes (PEM) in which the anode of the fuel cell is supplied with hydrogen as the fuel and the cathode is supplied with oxygen and/or air as the oxidizing agent. The anode and cathode are separated by a proton-permeable, electrically nonconducting membrane. Electrical power generated by the electrochemical reaction of hydrogen and oxygen to form water is picked off by electrodes at the anode and cathode. This reaction is sustainable only if the resulting current is withdrawn from the fuel cell. Several individual fuel cells connected in series electrically are combined to form a fuel cell stack.

U.S. Pat. No. 6,514,635 B2 describes a shutdown procedure for a fuel cell system in which the hydrogen supply to the anode and the outlet of the anode both remain open and the air supply to the cathode is closed. Once the cell voltage has dropped to a certain level, the hydrogen supply to the anode is cut off and air is sent into the anode.

One disadvantage of the procedure described here is that unconsumed hydrogen enters the exhaust of the fuel cell system through the opened anode outlet, and energy is also lost in the anode through the reaction of hydrogen with the supplied air.

The object of the present invention is to provide a method for shutting down a fuel cell system that will have low emission values and a high efficiency.

This object is achieved by a method having the features of claim 1.

The method according to the present invention is characterized in that during shutdown of the fuel cell system, the hydrogen supply to the anode is interrupted and the current generated from the residual hydrogen is supplied to an electrical consumer.

Using hydrogen to generate energy has the advantage that less hydrogen enters the exhaust of the fuel cell system, so emission levels are improved and thus the energy of the hydrogen is not lost but instead is sent to electrically powered devices, which thus increases the efficiency of the system. The method according to the present invention also makes it possible to shorten the shutdown procedure and reduce the noise production. The shortened duration of the shutdown procedure is advantageous in particular when the fuel cell system is to be shut down completely before being restarted and the system is thus ready to start again after a shorter period of time.

Prior to interruption of the hydrogen supply, the cell system is preferably initially in a defined state, in particular a no-load state if necessary, advantageously characterized by low pressure in the anode so that reproducible starting conditions prevail and the shutdown procedure is shortened due to the small amount of hydrogen at low pressure.

If the current is conducted via the electrical connection between the anode and the cathode, hydrogen and oxygen are consumed in the electrochemical reaction in the fuel cell. Due to the interruption in the hydrogen supply to the anode, the pressure in the anode drops. To avoid damaging the fuel cell, the pressure in the cathode is regulated in one embodiment of the present invention in such a way that the maximum deviation from the anode pressure is Δpₘₐₓ. If the pressure difference exceeds Δpₘₐₓ, it could damage the seals or the thin membrane, for example.

In another embodiment of the present invention, the electrical connection between the anode and the cathode is interrupted either when the hydrogen pressure upstream from the delivery device drops below a minimum pressure pH₂ₘᵢₙ and thus anode recirculation is no longer supported or the voltage on a fuel cell and/or on the fuel cell stack drops below a minimum voltage and thus the fuel cell could be damaged.

For technical or cost reasons, it may be advantageous to measure the voltage of two fuel cells instead of the voltage of a single fuel cell and use it as a termination condition accordingly.

A jet pump, which functions like a water jet pump according to the Venturi principle, may advantageously be used as the delivery device.

By controlling the current conducted from the fuel cell, the duration of the electrical connection between the anode and the cathode is determined advantageously by the fact that more hydrogen is consumed by the electrochemical reaction in the fuel cell at a higher current and thus the remaining quantity of hydrogen is reduced more rapidly and/or the hydrogen pressure is lowered more rapidly.

In another embodiment of the present invention, gas from the anode recycle loop is supplied to the cathode outlet in a metered manner via at least one controllable media line. This may take place while the electrical connection between the anode and the cathode is closed to improve the voltage measurement by increasing the flow of media in the anode. However, gas is discharged from the anode recycle loop only to the extent that a sufficiently high flow of media in the anode is ensured. If the electrical connection between the anode and cathode has been interrupted, residual hydrogen is supplied in a metered manner to the cathode outlet and the hydrogen pressure is reduced to ambient level. This has the advantage that, after the end of the shutdown procedure, the same defined state always prevails in the fuel cell system, so that a restart of the fuel cell system is facilitated and shortened.

If hydrogen is supplied to the cathode outlet, it is diluted by the cathode air to keep the hydrogen concentration in the exhaust of the fuel cell system as low as necessary. Control of the quantity of air from the cathode depends on the quantity of hydrogen supplied to the cathode outlet. This may take place in the cathode inlet by a device for conveying air, e.g., through a compressor or through an air storage mechanism having a higher pressure.

If the circulation of gas in the anode recycle loop is preferably supported by an electric-powered delivery device, e.g., a fan, then the electrical connection between the anode and the cathode may remain closed until the hydrogen is consumed to the point that the hydrogen pressure corresponds to ambient pressure. In this case, no hydrogen need be supplied to the cathode outlet and instead it may advantageously be utilized as electrical power.

The current generated by the hydrogen is preferably supplied to an electrical consumer of the fuel cell system, e.g., the compressor for the air supply or the fan in the anode recycle loop and/or an electrical storage device, in particular a battery. If the fuel cell system is used in a fuel cell vehicle, then the traction battery is preferably chosen as the storage device when supplying the electrical power to a storage device.

Additional features and combinations of features are derived from the description and the drawings. Concrete exemplary embodiments of the present invention are depicted in simplified diagrams in the drawing and explained in greater detail in the following description.

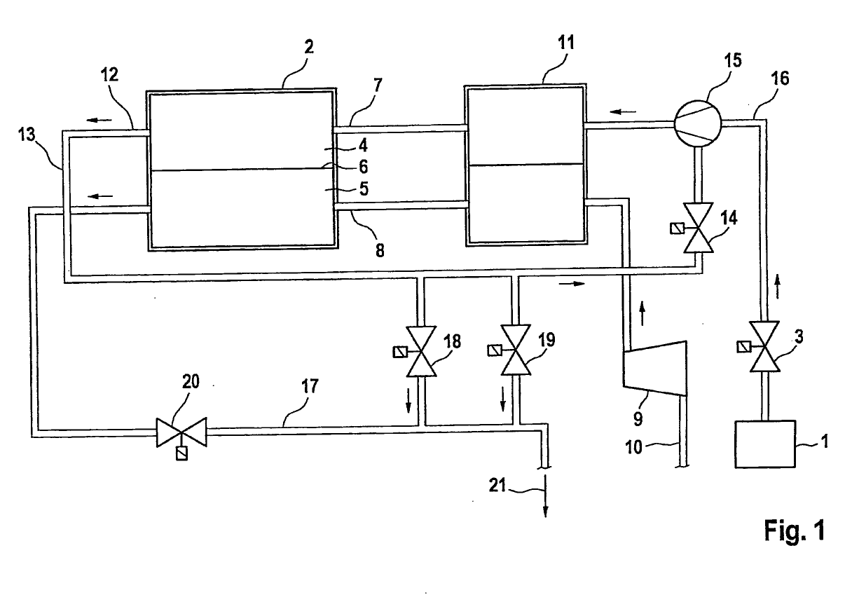

FIG. 1 shows the schematic layout of a fuel cell system, and

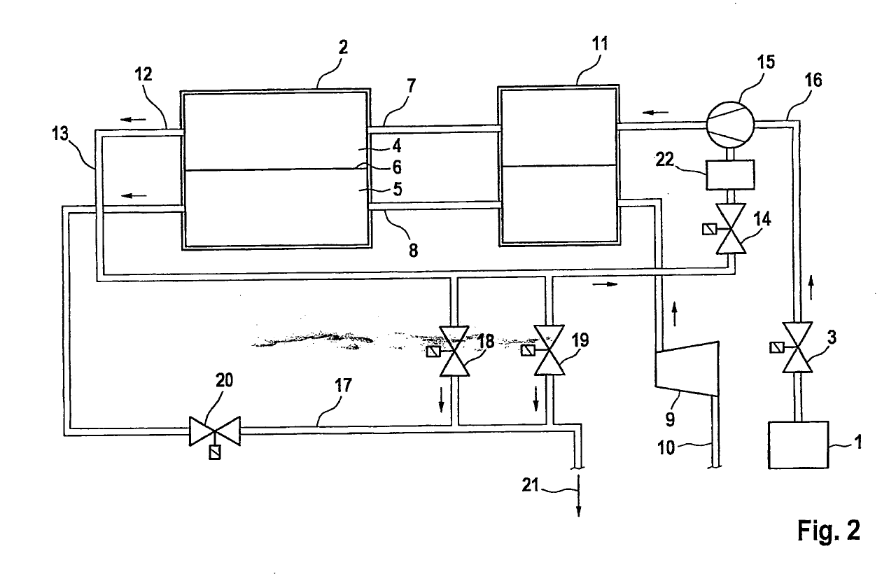

FIG. 2 shows the schematic layout of a fuel cell system with a fan.

FIG. 1 shows the layout of a fuel cell system such as that which may be used, for example, in a motor vehicle having an electric drive which is powered by this fuel cell system. The fuel cell system illustrated here includes a hydrogen tank 1, whose inlet line to a fuel cell 2 may be controlled via a valve 3. Fuel cell 2 here represents a fuel cell stack in which a plurality of fuel cells is connected electrically in series.

Fuel cell 2 includes an anode 4 and a cathode 5 separated by a proton-permeable and electrically nonconducting proton exchange membrane 6. Anode 4 is supplied with hydrogen as fuel through anode inlet 7. Cathode 5 is supplied with oxygen and/or air as the oxidizing agent through cathode inlet 8. The amount of air supplied is controlled by a compressor 9. A supply line 10 to compressor 9 indicates that compressor 9 draws in air from outside the vehicle.

Before entering fuel cell 2, the air and hydrogen flow through a humidifier 11, where the moisture content of the gas is increased to humidify proton exchange membrane 6.

From anode outlet 12, the hydrogen reaches a jet pump 15 via an anode recycle loop 13, which may include a valve 14. Jet pump 15 delivers hydrogen from anode recycle loop 13 into humidifier 11 due to the pressure difference between jet pump inlet 16 and the supply line to humidifier 11. When the hydrogen pressure at jet pump inlet 16 drops below pH₂ₘᵢₙ, this results in a pressure difference at jet pump 15 at which no more hydrogen is delivered from anode recycle loop 13.

In the embodiment illustrated in FIG. 1, anode recycle loop 13 is connected to cathode outlet 17 via two media lines. Flow-through of the two media lines is controlled by a valve 18, 19. To implement the method according to the present invention, one controllable media line may be sufficient. Likewise, more than two media lines may be used whose flow is controllable by a wide variety of devices. The flow through the two media lines shown here is regulated or controlled by temporary opening of two valves 18, 19.

Upstream from the two media lines, there is a valve 20 in cathode outlet 17 to regulate the cathode pressure in addition to the pressure being regulated by compressor 9.

The exhaust of the fuel cell system is discharged as indicated by arrow 21 at the end of cathode outlet 17. This may take place via the exhaust system of a vehicle, for example.

FIG. 1 does not show the electrical lines of the fuel cell system via which the electric current is withdrawn from fuel cell 2 or supplied to compressor 9, for example, or the lines for controlling the fuel cell system.

The shutdown procedure of the fuel cell system according to the present invention may be started in a vehicle, e.g., by turning off the ignition, by stopping the vehicle, or by initiating an emergency shutdown.

In normal operation of the fuel cell system in a vehicle, the absolute hydrogen pressure in anode 4 is between 1.6 bar and 3 bar, for example. The lower pressure of 1.6 bar occurs when the fuel cell system is in the no-load state. This condition is initiated if the system is to be shut down under load.

As the next step in the method according to the present invention, the hydrogen supply is interrupted by valve 3 to prevent a replenishing stream of hydrogen into the system.

After valve 3 has been closed, fuel cell 2 is still under pressure. This pressure is lowered by applying a load to fuel cell 2 and the associated conversion of the hydrogen. The electric current generated from the residual hydrogen is delivered to an electrical consumer such as compressor 9 or a battery.

The size of the applied load is selected according to the desired duration of hydrogen consumption. If the residual hydrogen is to be consumed rapidly, a maximum load of 50 amperes, for example, is applied to fuel cell 2. In a preferred method, a load of 10 amperes is selected at which the shutdown procedure takes about 10 seconds.

In order for the pressure difference between anode 4 and cathode 5 to not exceed a value Δpₘₐₓ of preferably 0.2 bar and thus to prevent damage to the seals in fuel cell 2 or membrane 6, the cathode pressure, regulated by valve 20 and compressor 9, is adjusted according to the anode pressure.

Termination conditions for applying a load to fuel cell 2 and the hydrogen consumption associated therewith include the hydrogen pressure at jet pump inlet 16 being too low (less than pH₂ₘᵢₙ=1.3 bar), the voltage on one fuel cell 2 and/or on two fuel cells measured jointly being too low, or a voltage on the fuel cell stack being too low. In a preferred fuel cell system in a vehicle, the fuel cell stack is made up of approximately 400 fuel cells 2.

For a more accurate measurement of the fuel cell voltage, a certain media flow in anode 4 is required. If the circulating media flow is no longer sufficient for this and if the media flow should therefore be increased, the media lines in cathode outlet 17 may be opened in a metered manner. Metering of the hydrogen directed to cathode outlet 17 is achieved by temporarily opening two valves 18, 19.

First, valve 18 is opened only temporarily in a clocked manner, the opening time being variable up to complete opening. When valve 18 is opened, it is possible to proceed accordingly with valve 19. Likewise, only one media line having corresponding regulation of the through-flow is possible. Diverting hydrogen into cathode outlet 17 also results in a shortening of the shutdown procedure.

If one of the aforementioned termination conditions is met, the load is disconnected from fuel cell 2 and hydrogen consumption is stopped. Residual hydrogen is supplied through the media lines to cathode outlet 17 until the hydrogen pressure reaches ambient level. During this time, compressor 9 is operated by another power source, e.g., a battery, to dilute the exhaust with cathode air according to the desired emission levels.

After the hydrogen has reached ambient pressure and is no longer flowing into the exhaust of the fuel cell system, compressor 9 and the remaining components of the system are shut down.

FIG. 2 shows a fan 22, situated between valve 14 and jet pump 15 in anode recycle loop 13, which supports the circulation of hydrogen in anode recycle loop 13 as needed. This is necessary when, for example, the media flow in anode 4 is too low for a sufficiently accurate voltage measurement or the hydrogen pressure at jet pump inlet 16 is below pH₂ₘᵢₙ and the circulation in anode recycle loop 13 is thus no longer being supported by jet pump 15.

Due to this support of the anode recirculation, a load may be applied to fuel cell 2 until the hydrogen has reached ambient pressure and the hydrogen may be consumed. Minimal hydrogen pressure pH₂ₘᵢₙ at jet pump inlet 16 thus no longer constitutes a termination condition. It is thus possible to omit the media lines to cathode outlet 17.

Whether the anode recirculation is advantageously supported by the media lines to cathode outlet 17 and/or by the diverted hydrogen or by fan 22 is made dependent on, for example, the consideration of the power generated in fuel cell 2 and/or the power needed by compressor 9 and fan 22.

1-9. (canceled)

10. A method for shutting down a fuel cell system, the fuel cell system having at least one fuel cell having an anode and a cathode, anode and cathode inlets, anode and cathode outlets, an anode recycle loop, a device for delivering gas in the anode recycle loop, and a hydrogen and air supply, the hydrogen supply to the anode being interrupted during shutdown and a current generated from residual hydrogen being supplied to an electrical consumer, the method comprising:
regulating pressure in the cathode so that the pressure in the cathode deviates from pressure in the anode maximally by a pressure Δpₘₐₓ of 0.2 bar.

11. The method as recited in claim 10 wherein the fuel cell system is first brought to a defined state.

12. The method as recited in claim 11 wherein the defined state is a no-load state.

13. The method as recited in claim 11 wherein the defined state is characterized by an absolute pressure in the anode of 1.6 bar.

14. The method as recited in claim 10 wherein an electrical connection between the anode and cathode is interrupted when a hydrogen pressure of the hydrogen supply drops below a minimum hydrogen pressure or a voltage drops below a minimum voltage on a fuel cell or below a minimum voltage on a fuel cell stack.

15. The method as recited in claim 10 wherein a duration of an electrical connection between the anode and cathode is controlled by the current supplied to the electrical consumer.

16. The method as recited in claim 10 wherein the gas from the anode recycle loop is supplied to the cathode outlet in a metered manner through at least one controllable media line.

17. The method as recited in claim 10 wherein circulation of the gas in the anode recycle loop is supported by a delivery device operated by electricity.

18. The method as recited in claim 10 wherein the electrical consumer is an electrical consumer of the fuel cell system and/or an electrical storage device.

19. The method as recited in claim 18 wherein the electrical storage device is a battery.

20. The method as recited in claim 10 wherein the at least one fuel cell is a fuel cell having a proton exchange membrane.

21. The method as recited in claim 10 wherein the device for delivering gas in the anode recycle loop is operated according to the Venturi principle.
